(19) United States
(12) Patent Application Publication
(10) Pub. No.: US 2009/0170744 A1
(43) Pub. Date: Jul. 2, 2009

(54) Washing, Cleaning and Care-Providing Agent

(75) Inventors: Georg Meine, Mettmann (DE); Hans-Juergen Riebe, Solingen (DE); Thomas Rechenbach, Hilden (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/349,709

(22) Filed: Jan. 7, 2009

Related U.S. Application Data
(63) Continuation of application No. PCT/EP2007/056456, filed on Jun. 28, 2007.

(30) Foreign Application Priority Data
Jul. 7, 2006 (DE) 10 2006 031 897.8
Apr. 23, 2007 (DE) 10 2007 019 428.7

(51) Int. Cl. C11D 7/54

(52) U.S. Cl. 510/302; 510/367

(57) ABSTRACT

Washing, cleaning, and care-providing agents that comprise a light-active bleaching-agent system based on titanium dioxide. The titanium dioxide is by preference a titanium dioxide modified with carbon. The washing, cleaning, and care-providing agents exert a good cleaning effect in the context of textile treatment, the treatment of hard surfaces, cosmetic treatment of the human body, and the improvement of (indoor) air, and have a low impact on the treated substrates.

### CROSS REFERENCE TO RELATED APPLICATIONS

This application is a continuation under 35 U.S.C. §§ 120 and 365(c) of International Application PCT/EP2007/056456, filed on Jun. 28, 2007. This application also claims priority under 35 U.S.C. § 119 of DE 10 2006 031 897.8 filed on Jul. 7, 2006 and DE 10 2007 019 428.7. The disclosures of PCT/EP2007/056456, DE 10 2006 031 897.8 and DE 10 2007 019 428.7 are incorporated by reference in their entirety.

### BACKGROUND OF THE INVENTION

The invention relates to a washing, care-providing, or cleaning agent that contains a light-active bleaching agent which encompasses titanium dioxide that by preference is modified. The invention further relates to methods for textile treatment, for treating hard surfaces, for cosmetic treatment of the human body, and for improving (indoor) air with the use of the light-active bleaching agent.

Washing, cleaning, and providing care for a wide variety of objects represents a basic human need, and modern industry is constantly attempting to meet these human needs in many way, by making available an incalculable variety of products in the field of the washing, cleaning, and care-providing agents.

Colored stains in particular, on textiles but also on hard surfaces, have always represented a particular challenge to the appropriate design of washing, care-providing, and cleaning agents, since such colored stains result in definite spots even in very small quantities, and are perceived as very obtrusive. In addition, many colored stains can adhere very tenaciously onto textile fibers or onto another surface. For these reasons, many washing, care-providing, or cleaning agents contain bleaching agents.

Included among those bleaching agents of the existing art that have become most widely distributed in conjunction with washing, care-providing, or cleaning agents are, in particular, the oxygen-based bleaching agents such as, for example, sodium perborate, sodium percarbonate, and hydrogen peroxide, as well as chlorine-based bleaching agents such as, for example, sodium hypochlorite.

These bleaching agents are associated with limitations in terms of utilization, however. Hydrogen peroxide as such has little shelf stability. Sodium perborate and sodium percarbonate are known to break down in water, forming hydrogen peroxide. The latter's bleaching effect is, however, highly dependent on temperature and pH. Below 60° C., the bleaching effect is low. Recourse is therefore often had to bleach activators such as N,N,N′,N′-tetraacetylethylenediamine (TAED) or p-nonanoyloxybenzenesulfonate (NOBS). Hydrogen peroxide does not possess sufficient bleaching capability in neutral or acid solution. Optimum bleaching effect is achieved only at pH 10-11.

In the case of the chlorine-based bleaching agents, for example sodium hypochlorite solutions, incompatibility problems with other washing-agent ingredients exist, so that the bleaching agent and washing agent often must be dispensed separately. A highly alkaline aqueous solution of sodium hypochlorite is generally necessary in order to stabilize the bleaching-agent solution. Acidification results in the release of chlorine gas that is hazardous to health.

In addition, the common bleaching agents such as hydrogen peroxide or sodium hypochlorite are too aggressive for many applications, in particular care-providing applications.

### DESCRIPTION OF THE INVENTION

The object of the present invention was therefore to make available a washing, care-providing, or cleaning agent having an alternative bleaching system.

This object was achieved, surprisingly, by the subject matter of the present invention, specifically by making available a washing, care-providing, or cleaning agent that contains a light-active bleaching agent which encompasses titanium dioxide, by preference modified titanium dioxide, in particular titanium dioxide modified with carbon.

The light-active bleaching agent according to the present invention encompasses (by preference, modified) titanium dioxide and can advantageously utilize radiation of the visible region of the spectrum, perceivable by the human eye and having wavelengths between 380 and 800 nm, for the purpose of photo-bleaching, and can thus exert a general cleaning effect, for example as a result of the incidence of daylight.

The light activity of the light-active bleaching agent advantageously refers to natural or artificial light having a wavelength in the region from 10 to 1200 nm, by preference 300 to 1200 nm, in particular between 380 and 800 nm.

Advantageously, even the light that is incident through glass windows into enclosed living spaces (diffuse daylight) is sufficient to achieve the cleaning that is aimed for (e.g. definite diminution in colored stains). Even light from industrial light sources (artificial light), for example from commercially available incandescent lamps (light bulbs), halogen lamps, fluorescent tubes, compact fluorescent lamps (energy-saving lamps), and from light sources based on light-emitting diodes, is sufficient to bring about the desired cleaning (e.g. spot removal).

A great advantage of the washing, care-providing, or cleaning agent is that it also dispenses with the use of technical equipment, e.g. a washing machine. For example, a spotted textile can be treated locally with the agent according to the present invention, for example by spraying or soaking, and the treated textile can then, for example, be hung on a clothesline so that a bleaching effect or general cleaning effect takes place by the action of light.

A further advantage of the washing, care-providing, or cleaning agent is that it is also suitable for portable application. For example, a coffee spot or red-wine spot can be sprayed with a liquid agent according to the present invention. The stained garment need not even be removed for the purpose.

The washing, care-providing, or cleaning agent according to the present invention exerts a general cleaning effect, and performs very good service in the removal of, in particular, colored stains with the aid of light, in particular with the aid of radiation in the visible region of the spectrum, perceptible to the human eye and having wavelengths between 380 and 800 nm. There is little impact on the treated substrates. Advantageously, the washing, care-providing, or cleaning agent according to the present invention can provide a general cleaning effect and, by preference, also perform good service in the removal of colored stains, with the aid of light in the wavelength region from 10 to 1200 nm, in particular also with the aid of UV radiation (wavelength 380 to 200 nm, by preference 380 to 320 nm).

The agent according to the present invention is particularly effective in the reduction or removal of spots that result from
red to blue anthocyanin dyes such as, for example cyanidine, e.g. from cherries or blueberries,
red betanidine from red beets,
orange-red carotenoids such as, for example, lycopene, beta-carotene, e.g. from tomatoes or carrots,
yellow curcuma dyes such as, for example, curcumin, e.g. from curry and mustard,
brown tanning agents, for example from tea, fruit, red wine,
dark-brown humic acid, e.g. from coffee, tea, cocoa,
green chlorophyll, e.g. from green grasses,
industrial dyes from cosmetics, inks, colored pens.

A further advantage of the agent according to the present invention is that bacteria and other microorganisms are also killed. This is an important contribution to a definite reduction in germ count, and thus to effective hygiene, e.g. laundry hygiene. A reduction in germs to a level that is safe for health is thereby achieved.

It is known that bacteria and fungi reproduce rapidly in a moist environment. With reference to textiles, for example, this means that reproduction of microorganisms fails to occur only when (washed) laundry is stored dry. Said microorganisms can, however, survive for several weeks on dry laundry. In a moist environment, however, a great deal of microorganism reproduction takes place on the laundry.

As a result of textile laundering at the lowest possible temperatures (30° C. and 40° C.), as is usual today, it may happen that germ reduction on the laundry is merely suboptimal even after machine laundering. When drying subsequently takes place in air, as opposed to drying in a clothes dryer, no further reduction in germs may be expected. On the contrary, bacterial growth can occur, especially in the case of slow air drying as is usual in today's largely urban civilization, since for lack of space or lack of access to outdoor areas, drying may take place only in poorly ventilated or enclosed spaces. For highly stressed articles of clothing (e.g. socks, underwear, dish towels), in particular, sufficient hygienic cleanliness then can no longer be guaranteed. The agent according to the present invention is particularly helpful here.

In the context of the treatment of objects, in particular textiles, with the agent according to the present invention, advantageously an effective quantity of (by preference, modified) titanium dioxide is applied onto the object surface, in particular textile surface. This then ensures an appropriate diminution in germs and a reduction in colored stains.

The same is also true for the treatment of hard surfaces, for example when cleaning floors. Here as well, advantageously an effective quantity of (by preference, modified) titanium dioxide is deposited onto the surface to be treated, and can exert its effect as a result of the action of light from the visible spectral region.

An effective quantity of (by preference, modified) titanium dioxide is already present when at least a gradual cleaning effect (e.g. bleaching effect) is achieved. This can easily be clarified in a routine test. The cleaning effect can also, for example, extend over several hours, for example as a function of the light irradiation or the nature or intensity of the stain.

A further advantage of the agent according to the present invention is that in addition to the advantageously occurring general cleaning effect, and in addition to the advantageously occurring hygienic effect, it can also advantageously be used in the mitigation, elimination, or neutralization of fetid odors. The fetid odor can advantageously be diminished in such a way that an odor impact no longer exists.

For the sake of clarity, be it noted that the washing, care-providing, or cleaning agents according to the present invention can involve not only washing, care-providing, or cleaning agents for textiles, but also washing, care-providing, or cleaning agents for hard surfaces (e.g. dishes, floors, tiles, glass, metal), and likewise washing, care-providing, or cleaning agents for cosmetic purposes, for example skin or hair washing and cleaning agents or care-providing agents. The term “care-providing agent” is also to be understood to mean those agents that serve to care for (indoor) air, i.e. so-called air improvers, room scenting agents, and air fresheners. (Indoor) air care agents according to the present invention must, however, contain at least one odorant such as, for example, an essential oil (such as, for example, conifer needle oils, citrus oil, eucalyptus oil, lavender oil, etc.). Essential oils that are particularly suitable according to the present invention can also be selected from the following group:

Angelica—Angelica archangelica, anise—Pimpinella anisum, Siam benzoin—Styrax tokinensis, cabreuva—Myrocarpus fastigiatus, cajeput—Melaleuca leucadendron, rock rose—Cistus ladaniferus, Copaiba balsam—Copaifera reticulata, costus root—Saussurea discolor, silver fir needles—Abies alba, elemi—Canarium luzonicum, fennel—Foeniculum dulce, spruce needles -Picea abies, geranium—Pelargonium graveolens, ho leaves—Cinnamonum camphora, immortelle (strawflower) Helichrysum angustifolia, ginger extra -Zingiber off, St. John's wort—Hypericum perforatum, jojoba, German chamomile—Matricaria recutita, blue chamomile—Matricaria chamomilla, Roman chamomile—Anthemis nobilis, wild chamomile—Ormensis multicaulis, carrot—Daucus carota, mountain pine—Pinus mugho, lavender—Lavendula hybrida, Litsea cubeba—(May Chang), manuka—Leptospermum scoparium, lemon balm—Melissa officinalis, maritime pine—Pinus pinaster, myrrh—Commiphora molmol, myrtle—Myrtus communis, neem—Azadirachta, niaouli (MQV)—Melaleuca quin. viridiflora, palmarosa—Cymbopogon martini, patchouli—Pogostemon patschuli, balsam of Peru—Myroxylon balsamum var. pereirae, Ravensara aromatica, rosewood—Aniba rosae odora, sage—Salvia officinalis horsetail—Equisetaceae, yarrow extra—Achillea millefolia, plantain—Plantago lanceolata, styrax—Liquidambar orientalis, Tagetes (marigold) Tagetes patula, tea tree—Melaleuca alternifolia, tolu balsam—Myroxylon balsamum L., Virginia cedar—Juniperus virginiana, frankincense (olibanum)—Boswellia carteri, silver fir—Abies alba.

Odorants such as, by preference, essential oils can be contained in all agents according to the present invention.

Also included in the concept of “care-providing agents” in the broadest sense are all decorative agents with which, for example, the colored decoration of walls or other surfaces can be effected by the application of lacquers, paints, and coating substances. A paint or coating substance is thus also a care-providing agent for purposes of the invention. Also advantageously included among the coating substances in the present context are substances such as, for example, size and paste, and dispersion, solvent, reaction, and contact adhesives.

The presentation of the agents according to the present invention is preferably based on the requirements of the intended utilization. Agents according to the present invention can be present in solid, semi-solid, liquid, dispersed, emulsified, suspended, aerosol, or gel form. Solid and liquid agents can be packaged, for example, in sachet or in (by preference, self-dissolving) portion pouches, in particular also in multi-chamber pouches. Included under the term “liquid” for purposes of the invention are also any dispersions of solids in liquids. Agents according to the present invention can also be present as pastes, salves, lotions, or creams. Solid agents can be present as pourable powders, as flakes, as solid blocks, as pieces (e.g. soap pieces), or as spheres or sticks or tablets, in particular multi-layer tablets.

It has proven to be very advantageous if the agent according to the present invention is contained in an opaque container or an opaque package.

A washing, care-providing, or cleaning agent according to the present invention that is contained in an opaque package therefore corresponds to a preferred embodiment of the invention.

The opaque package makes possible improved shelf stability for the washing, care-providing, or cleaning agent according to the present invention.

Those washing, care-providing, or cleaning agents that are present not in solid but in liquid, dispersed, emulsified, suspended, aerosol, or gel form benefit in particular from an opaque package. Solid and semi-solid washing, care-providing, or cleaning agents also benefit, however, from an opaque package.

If the washing, care-providing, or cleaning agent according to the present invention is therefore present in solid, semi-solid, liquid, dispersed, emulsified, suspended, aerosol, or gel form in an opaque package, this then corresponds to a preferred embodiment.

Liquid laundry detergents, liquid cleaning agents, and liquid textile treatment agents such as, for example, conditioners or hygienic rinses, benefit in particular from an opaque package.

The provision of opaque packages presents the skilled artisan with no problems. Particularly preferred packaging materials are, in particular, polyethylene and polypropylene. If the material of the opaque package therefore encompasses polyethylene and/or polypropylene, a preferred embodiment is then present. The package materials can also be colored and/or coated.

It is especially advantageous if the package is opaque to electromagnetic radiation in the wavelength region from 10 to 1200 nm, by preference 380 to 800 nm. This corresponds to a preferred embodiment. “Opaque” or “impermeable” means that the transmittance, i.e. permeability, of the package with respect to light, in particular electromagnetic radiation in the wavelength region from 10 to 1200 nm, by preference 380 to 800 nm, is reduced by at least 50%, 60%, 70%, 80%, 90%, 95%, or even 99% as compared with a barrier-free state, i.e. complete light transmission. It is most advantageous if the opacity of the package is absolute. The transmittance can be determined with usual spectroscopic or photometric methods, utilizing usual spectrometers or photometers.

In a particular embodiment, the agents according to the present invention are present in liquid form. Application can, in this context, occur by preference using spray apparatuses. These spray apparatuses contain, in a container, a filling of the (liquid, pasty, or powdered) washing, care-providing, or cleaning agent according to the present invention. The filling can be pressurized by a propellant (compressed-gas canisters, pressurized-gas packages, aerosol packages), or a mechanically operated pump atomizer (pump spray) can be involved. The containers comprise a removal apparatus, by preference in the form of valves that enable removal of the content as a mist, fog, foam, powder, paste, or a stream of liquid. Especially suitable as containers for the spray apparatuses are cylindrical vessels made of metal (aluminum, tinplate, volume by preference<1000 ml), protected or shatterproof glass or plastic (volume by preference<220 ml), or non-shatterproof glass or plastic (volume by preference<150 ml).

Application can also be accomplished by preference, for example in the case of liquid agents, using a roller applicator as known, for example, from the sector of roll-on deodorants. Such rollers comprise a ball, mounted in a ball socket, that can be moved by motion over a surface. The ball thereby picks up some of the agent to be distributed, and conveys it onto the surface to be treated.

Application can also be accomplished, for example, using so-called moist wipes, i.e. moist wipes prefabricated for the user and preferably individually packaged, such as those that are familiar, for example, from the sector of glass cleaning (eyeglass cleaning cloths) or the sector of moist toilet papers. Moist wipes of this kind, which can advantageously also contain preservatives, are then advantageously impregnated or impinged upon with an agent according to the present invention; advantageously, they are individually packaged. They can then be used, for example, as a portable spot removing agent. If a consumer, for example, accidentally gets a red-wine spot on his shirt, he can take a moist wipe of this kind and, by rubbing the moist wipe on the spotted textile, advantageously remove the spot or at least decrease the blemish.

The agents according to the present invention, by preference liquid agents, can also be multi-phase; the phases can be, for example, arranged horizontally, i.e. one above another, or arranged vertically, i.e. beside one another. A dispersed system can also be present, in which, for example, the solid constituents are distributed inhomogeneously in the liquid matrix, so that a dispersed system of this kind should be shaken before use.

Preferred washing agents for purposes of the invention are, among others, the so-called washing adjuvants for textiles. These include, in particular:
a) Spot intensifiers such as, for example, grease removers. These serve predominantly for (pre-)treatment of locally occurring grease and/or pigment stains, and are applied directly onto the textiles.
b) Soaking agents. These are adjuvants usually adjusted to greater alkalinity (up to approx. pH 13) with a lower surfactant content. They promote swelling processes in stains, and decrease stain adhesion.
c) Separate bleaching agents, such as spot salts, liquid bleaches, washing power intensifiers. They can be used both as laundry detergent additives and for pretreatment.
d) Separate softeners, preferably containing builders such as, for example, citrates and/or zeolites, and dispersion agents such as, for example, polycarboxylates.
e) Separate discoloration inhibitors.
f) Specific spot removal agents for individual types of spots.
g) Textile pretreatment agents, preferably liquid or pasty, preferably spray, for targeted spot pretreatment.

Preferred agents for purposes of the invention are also post-treatment agents for textiles. These include, in particular:
a) Fabric softeners, also called finishing agents or fabric conditioners, as well as corresponding sheets for dryer application.
b) Laundry stiffeners, which have the effect of imparting a stiff and full conformation to the laundry.
c) Shaping rinses, which have the effect of strengthening the fiber structure of textiles treated therewith so that the laundry achieves a feel ranging from light (finished) to heavy (starched).
d) Hygiene rinses, which by preference are added to the last rinse cycle and contain an antimicrobial active substance as well as, by preference, nonionic surfactants.
e) Ironing aids, which e.g. are sprayed on and have a fiber-smoothing effect to a certain extent even without ironing, for example if the still-wet laundry is smoothed by hand after spraying.
f) (Curtain) whitening agents, whose purpose is to increase the whiteness (of curtains) and optionally to have a fiber-strengthening effect.
g) Care-providing rinses that equip the textile, in the context of textile treatment (e.g. machine laundering) with active substances (e.g. oils) that can be delivered onto human skin when the textile is worn, and impart an advantage to the skin or provide care to it.
h) Ironing water, which advantageously comprises low-mineral or deionized water, preferably preservatives, and fragrances, for use when steam ironing.
i) Textile fresheners, i.e. products that remove odors from many textile materials, e.g. by encapsulation of the odors to be removed with the aid of suitable agents such as, for example, cyclodextrins, or by way of other active substances such as, for example, zinc ricinoleate.
j) Liquid post-treatment agents, preferably sprays, for targeted spot (post-)treatment.

Any textile treatment agents quite generally, such as, for example, washing agents or fabric softeners, in liquid and in solid form, are particularly preferred. Preferred agents for purposes of the invention are therefore washing agents. These include, in particular:
a) Complete laundry detergents (preferably containing bleaching agent, optical brighteners, enzymes, etc.)
b) Color washing agents (preferably containing discoloration inhibitors, cellulases, etc.)
c) Delicate washing agents (preferably of lower alkalinity)
d) Special washing agents such as, for example, in particular:
   i) Woolen washing agents (preferably pH-neutral),
   ii) Curtain washing agents,
   iii) Washing agents for hand-washing,
   iv) Washing agents having additional benefits, such as preferably:
      Washing agents having odor absorbers
      UV-protection washing agents
      Hygiene washing agents
      Ironing-facilitating washing agents
      Special washing agents for black or white laundry
      Sensitive washing agents, preferably containing care-providing substances such as, for example, almond oil, aloe vera extract, etc.
      Fragrance-intensive or perfumed washing agents.
         Among the most preferred cleaning agents are, in particular, hand dishwashing agents and automatic dishwashing agents.

Included among the preferred cleaning agents are, among others, the toilet cleaners or bowl cleaners, i.e. products for cleaning toilet bowls and urinals, which are offered by preference as powders, tablets, shaped elements, or liquids, by preference gels. In addition to other usual ingredients such as surfactants, they usually contain organic acids (e.g. citric acid and/or lactic acid) or sodium hydrogensulfate, sulfamic acid, or phosphoric acid for the removal of lime deposits or so-called urine scale.

Also included among the preferred cleaning agents are, among others, the pipe cleaning agents or drain cleaners. These are by preference highly alkaline preparations that as a rule serve to eliminate pipe clogs made of organic materials, such as hair, grease, food residues, soap deposits, etc. Aluminum- or zinc-powder additives can serve to form H₂ gas with an effervescent effect. Possible ingredients are alkalis in general, alkaline salts, oxidizing agents, and neutral salts. Powdered presentation forms preferably also contain sodium nitrate and sodium chloride. Pipe cleaning agents in liquid form can, by preference, also contain hypochlorite. In addition, enzyme-based drain cleaners also exist. Acid preparations are likewise possible.

Also included among the preferred cleaning agents are, among others, the universal or all-purpose cleaners. These are universally usable cleaners for all hard surfaces in the home and in commercial settings, which can be wiped off while wet or moist. These are generally neutral or weakly alkaline or weakly acid products, in particular liquid products. All-purpose cleaners generally contain surfactants, detergency builders, solvents and hydrotropes, dyes, preservatives, etc.

Specifically disinfecting all-purpose cleaners also exist. These additionally contain antimicrobial active substances (e.g. aldehydes, alcohols, quaternary ammonium compounds, amphoteric surfactants, triclosan, chlorhexidine, salicylic acid, benzoic acid).

Also included among the preferred cleaning agents are, among others, the sanitary cleaners. These are products for bathroom and toilet cleaning. The alkaline sanitary cleaners are preferably used for the removal of greasy dirt, while the acid sanitary cleaners are utilized principally for the removal of lime deposits. Sanitary cleaners also, advantageously, have a considerable disinfecting effect, especially the highly alkaline, chlorine-containing sanitary cleaners.

Also included among the preferred cleaning agents are, among others, the oven cleaners or grill cleaners, which advantageously are offered the form of gels or foam sprays. These generally serve for the removal of baked-on or carbonized food residues. Oven cleaners are by preference adjusted to high alkalinity, for example using sodium hydroxide, sodium metasilicate, 2-aminoethanol. As a rule, they furthermore contain anionic and/or nonionic surfactants, water-soluble solvents, and in some cases thickening agents such as polycarboxylates, carboxymethyl cellulose.

Also included among the preferred cleaning agents are, among others, the metal cleansing agents. These are cleaners for specific metal types such as stainless steel or silver. Stainless-steel cleaners by preference also contain, in addition to acids (by preference up to 3 wt %, for example, citric acid, lactic acid), surfactants (in particular up to 5 wt %, by preference, nonionic and/or anionic surfactants), and water, solvents (preferably up to 15 wt %) for the elimination of grease-containing stains, and further substances such as, for example, thickeners and preservatives. Very fine polishing elements are also contained in products for, by preference, shiny stainless-steel surfaces. Silver cleansing agents in turn are preferably adjusted to be acidic. They preferably contain complexing agents (e.g. thiourea, sodium thiosulfate), in particular for the removal of black silver sulfide deposits. Typical presentation forms are cleansing cloths, immersion baths, pastes, liquids. Copper and non-ferrous metal cleaners (e.g. for brass and bronze) serve for the elimination of dark discolorations (oxide layers). They are usually adjusted (preferably with ammonia) to be weakly alkaline, and as a rule contain polishing agents as well as, by preference, ammonium soaps and/or complexing agents.

Also included among the preferred cleaning agents are, among others, the glass cleaners or window cleaners. These serve by preference for the elimination in particular of grease-containing dirt from glass surfaces. They preferably contain substances such as anionic and/or nonionic surfactants (preferably up to 5 wt %), ammonia and/or ethanolamine (in particular up to 1 wt %), ethanol and/or 2-propanol, glycol ethers (in particular 10 to 30 wt %), water, preservatives, dyes, condensation-prevention agents, etc.

Also included among the preferred cleaning agents are, among others, all special cleaning agents, for example those for cooktops made of glass ceramic, as well as carpet and upholstery cleaners and spot removal agents.

Products preferred according to the present invention are also automobile care agents. Included among the preferred automobile care agents are, among others, paint preservers, paint polishes, paint cleaners, wash-on preservatives, car washing shampoos, car washing and waxing products, polishes for metal trim, protective films for metal trim, plastics cleaners, tar removers, wheel cleaners, engine cleaners, etc.

Preferred cosmetic agents are, by preference:
a) Cosmetic agents for skin care, in particular bath preparations, skin washing and cleaning agents, skin-care agents, eye cosmetics, lip care agents, nail care agents, personal care agents, foot care agents, skin bleaching agents.
b) Cosmetic agents having a special care-providing effect, in particular light-protection agents, skin tanning agents, depigmentation agents, deodorants, antiperspirants, hair removal agents, shaving agents, scenting agents, fingernail bleaching agents.
c) Cosmetic agents for dental care, in particular dental and oral care agents, dentition care agents, dental prosthesis cleaning agents, dental prosthesis adhesion agents, tooth bleaching agents, dental prosthesis bleaching agents.
d) Cosmetic agents for hair care, in particular hair washing agents, hair care agents, hair strengthening agents, hair reshaping agents, hair coloring agents, hair bleaching agents.

Particularly preferred agents are also the air improvers and room scenting agents. These agents serve for cleaning, olfactory enhancement, or improvement (i.e. care) of (indoor) air. Such products contain volatile and usually pleasant-smelling substances that advantageously, even in very small quantities, can cover up unpleasant odors. Air improvers for living spaces contain, in particular, odorants, such as preferably natural and synthetic essential oils such as conifer needle oils, citrus oil, eucalyptus oil, lavender oil, etc., for example in quantities up to 50 wt %. As aerosols they contain rather smaller quantities of such essential oils, for example less than 5 wt % or less than 2 wt %, but by preference additionally contain substances such as acetaldehyde (in particular <0.5 wt %), isopropyl alcohol (in particular <5 wt %), mineral oil (in particular <5 wt %), and propellant gases. Other administration forms are sticks and blocks. A gel concentrate of essential oils is preferably used in their manufacture. Formaldehyde (for preservation) and chlorophyll (preferably <5 wt %) can advantageously also be added, as well as further ingredients.

Air improvers are not limited to living spaces, however, but can also be provided for automobiles, closets, automatic dishwashers, refrigerators, and shoes; and utilization in vacuum cleaners is also possible. Also used in the home (e.g. in closets) in addition to the odor improvers are, for example, disinfection agents that preferably contain substances such as calcium phosphate, talc, stearin, and essential oils, for example in the form of sachets.

The agent according to the present invention can be used directly or indirectly for the scenting of an object, a surface, or a space, by preference of textile fabrics, household surfaces, shoes, waste receptacles, recycling receptacles, air, large household appliances, cat litter, domestic animals, domestic animal sleeping areas, in particular of articles of clothing, rugs, carpeted floors, drapes, curtains, upholstered furniture, bed linens, tents, sleeping bags, automobile seats, automobile carpets, automobile interior textile panels, shelf surfaces, walls, floors, bathroom surfaces, kitchen surfaces, refrigerators, freezers, washing machines, automatic dishwashers, clothes dryers, ovens, and microwave ovens. The agent can be applied in any form, for example sprayed on by means of a spray applicator.

The (by preference, modified) titanium dioxide is contained in the agent according to the present invention advantageously in quantities from 0.000001 to 25 wt %, by preference 0.01 to 5 wt %, based on the entire agent. The lower limit for the (by preference, modified) titanium dioxide can also be 0.00001 wt %, 0.00005 wt %, 0.0001 wt %, 0.0005 wt %, 0.001 wt %, or 0.005 wt %, based on the entire agent. The upper limit for the (by preference, modified) titanium dioxide can also be 20 wt %, 15 wt %, 10 wt %, 5 wt %, 1 wt %, 0.5 wt %, 0.1 wt %, 0.05 wt %, 0.01 wt %, 0.005 wt %, 0.001 wt %, 0.0005 wt %, 0.0001 wt %, 0.00005 wt %, 0.00001 wt %, or 0.000005 wt %, based on the entire agent.

The preferably modified titanium dioxide contained in the agent according to the present invention can advantageously have a particle size in the range between 2 and 600 nm, i.e. for example 3 to 150 nm, or for example 4 to 100 nm, or for example 5 to 75 nm, or for example 10 to 30 nm, or for example 200 to 400 nm. The particle size of the preferably modified titanium dioxide can by preference be in the range from 100 to 500 nm, advantageously 200 to 400 nm. It may also be preferred for the particle size to be very small, e.g. in the range from 2 to 150 nm, by preference 3 to 100 nm, advantageously 4 to 80 nm, or for example 5 to 50 nm, or for example 8 to 30 nm, or for example 10 to 20 nm. The particle size can, for example, advantageously assume values such as 5 nm, 10 nm, 15 nm, 20 nm, 25 nm, 30 nm, 35 nm, 40 nm, 45 nm, 50 nm, or 60 nm. Very small particle sizes below 50 nm, below 40 nm, below 30 nm, or below 20 nm can, in particular, be preferred.

It may be advantageous to proceed, in the manufacture of the modified titanium dioxide, from micronized titanium dioxide, i.e. from titanium dioxide having a very small particle size, for example between 2 and 150 nm, or for example between 5 and 100 nm. The particle size can then, for example, advantageously assume values such as 5 nm, 10 nm, 15 nm, 20 nm, 25 nm, 30 nm, 35 nm, 40 nm, 45 nm, 50 nm, or 60 nm. Such values are preferred.

The specific surface area according to BET for the preferably modified titanium dioxide is advantageously 50 to 500 m²/g, by preference 100 to 400 m²/g, with further advantage 200 to 350 m²/g, in particular 250 to 300 m²/g.

The bulk density of the preferably modified titanium dioxide is by preference in the range from 100 to 800 g/l, advantageously from 200 to 600 g/l, in particular from 300 to 500 g/l. The bulk density can be, for example, 350 g/l, 400 g/l, or 500 g/l.

According to a preferred embodiment, the (by preference, modified) titanium dioxide is a titanium dioxide modified with carbon. Titanium dioxides modified in other ways can, however, also be used, for example titanium dioxide modified with nitrogen, or titanium dioxide doped, for example, with rhodium and/or with platinum ions. It is, however, particularly preferred according to the present invention that the titanium dioxide be one modified with non-metals.

The carbon content of the titanium dioxide advantageously modified with carbon can, in a preferred embodiment, be in the range from 0.01 to 10 wt %, by preference from 0.05 to 5.0 wt %, advantageously from 0.3 to 1.5 wt %, in particular from 0.4 to 0.8 wt %. The TiO₂ concentration of the titanium dioxide modified with carbon is advantageously, for example, above 95 wt %, 96 wt %, 97 wt %, 98 wt %, or 99 wt %, based on the entire carbon-modified titanium dioxide.

If the carbon is deposited only in a surface layer of the titanium dioxide particles, a preferred embodiment then exists. The modified titanium dioxide can, advantageously, additionally contain nitrogen.

If the specific surface area of the titanium dioxide, by preference of the modified titanium dioxide, according to BET (BET determined advantageously according to DIN ISO 9277: 2003-05, by preference in simplified fashion also according to DIN 66132: 1975-07), equals by preference 50 to 500 m²/g, advantageously 100 to 400 m²/g, with further advantage 200 to 350 m²/g, in particular 250 to 300 m²/g, a preferred embodiment once again exists.

According to a preferred embodiment, the titanium dioxide modified with carbon can be obtained, for example, by intimately mixing a titanium compound that has a specific surface area of, by preference, at least 50 m²/g according to BET with an organic carbon compound, and heat-treating the mixture at a temperature of up to 350° C.

The carbon-containing substance that is usable in this context can be, according to a preferred embodiment, a carbon compound that contains at least one functional group, by preference selected from OH, CHO, COOH, NHx, SHx. The carbon compound can in particular be a compound from the group of ethylene glycol, glycerol, succinic acid, pentaerythritol, carbohydrates, sugar, starch, alkylpolyglucosides, organoammonium hydroxides, or mixtures thereof. It is also possible for carbon black or activated carbon to be used as a carbon-containing substance.

It may also be preferred for the carbon-containing substance, which is advantageously mixed with the titanium compound in order to arrive at the modified titanium dioxide after heat treatment, to have a decomposition temperature of at most 400° C., preferably <350° C., and particularly preferably <300° C.

The titanium compound usable by preference for manufacture of the modified titanium dioxide, which compound is intimately mixed, in accordance with the aforementioned preferred embodiment, with an organic carbon compound, can be an amorphous, partly crystalline, or crystalline titanium dioxide, or a hydrous titanium dioxide or a titanium hydrate or a titanium oxyhydrate, which in turn corresponds to a preferred embodiment.

According to a preferred embodiment, heat treatment of the mixture of the titanium compound and the carbon compound can advantageously be carried out in a calcining unit to be operated continuously, by preference a rotary kiln.

Especially in the context of what has been described above, the modified titanium dioxide can by preference be obtained, for example, by taking a titanium dioxide (e.g. having a particle size in the range between 2 and 600 nm, or for example 3 to 150 nm, or for example 4 to 100 nm, or for example 5 to 75 nm, or for example 10 to 30 nm, or for example 200 to 400 nm), as obtainable e.g. in commercially usual fashion in powder or slurry form, and manufacturing therefrom a suspension in a liquid such as, by preference, water. A carbon-containing substance is then advantageously added to the suspension, and mixing is performed. Mixing can be assisted by the use of ultrasound. The mixing operation (e.g. stirring) can by preference last for several hours, by preference 2, 4, 6, 8, 10, or 12 hours, or even longer. The quantity of carbon compound, based on the solids of the suspension, is advantageously 1 to 40 wt %; the quantity of the titanium compound is accordingly by preference 60 to 99 wt %.

The liquid is then removed, for example by filtration, vacuum evaporation, or decanting, and the residue is by preference dried (e.g. by preference at temperatures from 70 to 200° C., advantageously over several hours, for example at least 12 hours), and then calcined, for example at a temperature of at least 260° C., by preference e.g. at 300° C., by preference over a period of several hours, by preference 1 to 4 hours, in particular 3 hours. Calcination can advantageously take place in a closed vessel.

It may be advantageous that the calcining temperature, for example 300° C., is reached within one hour (slow heating to 300° C.). A color change in the powder, from white through dark brown to beige or light brownish-yellow, is preferably to be observed. Heating for too long results in an inactive, colorless powder. The skilled artisan can estimate this with a few routine experiments. Calcination can advantageously occur, for example until, after a color change in the powder from white through dark brown, a further color change to beige or light brownish-yellow takes place.

A maximum temperature of 350° C. should preferably not be exceeded in this context. In the context of the heat treatment, a decomposition of the organic carbon compound on the surface of the titanium compound takes place, so that by preference a modified titanium dioxide that by preference contains 0.005 to 4 wt % carbon is produced.

After heat treatment, the product is advantageously deagglomerated using known methods, for example in a pinned disk mill, air-jet mill, or counterjet mill. The particle fineness to be achieved depends on the grain size of the initial titanium compound. The particle fineness or specific surface area of the product is only slightly less than, but on the same order as, that of the educt. The photocatalyst particle fineness aimed for depends on the field of application of the photocatalyst. It is usually in the same range as for TiO₂ pigments, but can also be less or greater.

The particle size of the modified titanium dioxide can by preference be in the range from 2 to 600 nm, by preference in the range from 100 to 500 nm, advantageously 200 to 400 nm. It may also be preferred for the particle size to be very small, e.g. in the range from 2 to 150 nm, by preference 3 to 100 nm, advantageously 4 to 80 nm, or for example 5 to 50 nm, or for example 8 to 30 nm, or e.g. 10 to 20 nm.

It may be advantageous to proceed, in the manufacture of the modified titanium dioxide, from micronized titanium dioxide, i.e. from titanium dioxide having a very small particle size, e.g. between 2 and 150 nm, or e.g. between 5 and 100 nm. The particle size can then, for example, advantageously assume values such as 5 nm, 10 nm, 15 nm, 20 nm, 25 nm, 30 nm, 35 nm, 40 nm, 45 nm, 45 nm, 50 nm, or 60 nm. Such values are preferred.

The specific surface area according to BET for the preferably modified titanium dioxide is advantageously 50 to 500 m²/g, by preference 100 to 400 m²/g, with further advantage 200 to 350 m²/g, in particular 250 to 300 m²/g.

The bulk density of the preferably modified titanium dioxide is by preference in the range from 100 to 800 g/l, advantageously from 200 to 600 g/l, in particular from 300 to 500 g/l. The bulk density can be, for example, 350 g/l, 400 g/l, or 500 g/l.

According to a preferred embodiment, the (by preference, modified) titanium dioxide is present in the anatase crystal modification.

In a preferred embodiment of the invention, the agents according to the present invention such as, for example, washing or cleaning agents can also contain cyclodextrins, polyvinylamines, and/or polyethyleneimines, but by preference cyclodextrin/TiO₂ complexes, in particular based on the modified TiO₂ as described previously.

A further subject of the invention is constituted by a method for treating a textile, encompassing bringing the textile into contact with a washing, care-providing, or cleaning agent according to the present invention, during and/or followed by an exposure of the surface of the treated material to light having a wavelength in the range from 300 to 1200 nm, by preference 400 to 800 nm. For a preferred exertion of the effectiveness of the photo-bleaching agent, the presence of, by preference, oxygen and/or water (e.g. from air, i.e. atmospheric moisture) is necessary. The dissolved oxygen present in water, or the oxygen dissolved in moisture, or atmospheric oxygen, are sufficient, for example, for this. Illumination can also take place in a treatment bath. Light in the wavelength region from 10 to 1200 nm is usable for the aforesaid method.

This method offers the advantages of photodisinfection, good color and textile protection, and generally low substrate impact. The removal of spots from the treated fabric is also considerably improved. For clarification, be it noted that the liquid washing, care-providing, or cleaning agent usable in the method according to the present invention can by all means comprise only the components of (by preference, modified) titanium dioxide and a solvent, by preference encompassing water. Advantageously, however, surfactants and, if applicable, further optional ingredients are also contained in such liquid washing, care-providing, or cleaning agents. Possible ingredients that are usable in the method are described below.

A further subject of the invention is constituted by a method for treating hard surfaces, encompassing bringing the hard surface into contact with a washing, care-providing, or cleaning agent according to the present invention, during and/or followed by an exposure of the surface to light having a wavelength in the range from 300 to 1200 nm, by preference 400 to 800 nm. For a preferred exertion of the effectiveness of the photo-bleaching agent, the presence of, by preference, oxygen and/or water (e.g. from air, i.e. atmospheric moisture) is necessary. The dissolved oxygen present in water, or the oxygen dissolved in moisture, or atmospheric oxygen, are sufficient, for example, for this. Illumination can also take place in a treatment bath. Light in the wavelength region from 10 to 1200 nm is usable for the aforesaid method.

This method, too, offers the advantages of photodisinfection and a generally low substrate impact, as well as good color and material protection of the treated surface. The removal of stains from the treated surface is considerably improved.

A further subject of the invention is constituted by a method for cosmetic treatment of the human body, encompassing bringing the body parts (e.g. skin, hair, teeth) into contact with a washing, care-providing, or cleaning agent according to the present invention, during and/or followed by an exposure of the surface to light having a wavelength in the range from 300 to 1200 nm, by preference 400 to 800 nm. For a preferred exertion of the effectiveness of the photo-bleaching agent, the presence of, by preference, oxygen and/or water (e.g. from air, i.e. atmospheric moisture) is necessary. The dissolved oxygen present in water, or the oxygen dissolved in moisture, or atmospheric oxygen, are sufficient, for example, for this. Illumination can also take place in a treatment bath. This method, too, has a particularly low impact. Light in the wavelength region from 10 to 1200 nm is usable for the aforesaid method.

A further subject of the invention is constituted by a method for improving (indoor) air, encompassing bringing the air (e.g. by spraying) into contact with a washing, care-providing, or cleaning agent according to the present invention, containing at least one odorant such as, by preference, an essential oil, during and/or followed by irradiation with light having a wavelength in the range from 300 to 1200 nm, by preference 400 to 800 nm. For a preferred exertion of the effectiveness of the photo-bleaching agent, the presence of, by preference, oxygen and/or water (e.g. from air, i.e. atmospheric moisture) is necessary. The dissolved oxygen present in water, or the oxygen dissolved in moisture, or atmospheric oxygen, are sufficient, for example, for this. Light in the wavelength region from 10 to 1200 nm is usable for the aforesaid method.

For clarification, be it noted here as well that a liquid washing, care-providing, or cleaning agent usable in the method according to the present invention can by all means comprise only the components of (by preference, modified) titanium dioxide and a solvent. Only in the method for improving (indoor) air is an odorant, by preference an essential oil, obligatorily present as an additional component. Also advantageously contained in liquid washing, care-providing, or cleaning agents, however, are surfactants and, if applicable, further optional ingredients. Possible ingredients that are usable in the method are described below.

The washing, care-providing, or cleaning agents according to the present invention can contain further ingredients in addition to the (by preference, modified) titanium dioxide. Be it noted that the term “care-providing agents” also encompasses the conditioning agents.

According to a preferred embodiment, the washing, care-providing, or cleaning agent according to the present invention comprises, in addition to the (by preference, modified) titanium dioxide, at least one further, by preference multiple, ingredients, in particular ingredients having washing, care-providing, and/or cleaning activity, advantageously selected from the group encompassing anionic surfactants, cationic surfactants, amphoteric surfactants, nonionic surfactants, acidifying agents, alkalizing agents, anti-creasing compounds, antibacterial substances, antioxidants, anti-redeposition agents, antistatic agents, builder substances, bleaching agents, bleach activators, bleach stabilizers, bleach catalysts, ironing adjuvants, cobuilders, dispersion agents, shrinkage preventers, electrolytes, enzymes, color protection substances, coloring agents, dyes, color transfer inhibitors, fluorescent agents, fungicides, germicides, odor-complexing substances, adjuvants, hydrotropes, rinsing agents, complexing agents, preservatives, corrosion inhibitors, optical brighteners, perfume carriers, luster agents, pH adjusting agents, proofing and impregnation agents, polymers, odorant(s) (perfume (oil)), swelling and anti-slip agents, foam inhibitors, sheet silicates, dirt-repelling substances, silver protection agents, silicone oils, UV-protection substances, viscosity regulators, thickening agents, discoloration inhibitors, graying inhibitors, vitamins, and/or softening rinses.

Preferred ingredients of the agents according to the present invention will be described in more detail below.

Anionic surfactants are preferably contained in the agents according to the present invention. Anionic surfactants that can be used are, for example, those of the sulfonate and sulfate types. Possibilities as surfactants of the sulfonate type are, by preference, C₉₋₁₃ alkylbenzenesulfonates, olefinsulfonates, i.e. mixtures of alkene- and hydroxyalkanesulfonates, and disulfonates, for example such as those obtained from C₁₂₋₁₈ monoolefins having an end-located or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis and neutralization. The esters of α-sulfo fatty acids (estersulfonates), e.g. the α-sulfonated methyl esters of hydrogenated coconut, palm-kernel, or tallow fatty acids, are likewise suitable.

Further suitable anionic surfactants are sulfonated fatty acid glycerol esters. Preferred alk(en)yl sulfates are the alkali, and in particular sodium, salts of the sulfuric acid semi-esters of the C₁₂-C₁₈ fatty alcohols, for example from coconut fatty alcohol, tallow fatty alcohol, lauryl, myristyl, cetyl, or stearyl alcohol, or the C₁₀-C₂₀ oxo alcohols, and those semi-esters of secondary alcohols of those chain lengths. Additionally preferred are alk(en)yl sulfates of the aforesaid chain length that contain a synthetic straight-chain alkyl radical produced on a petrochemical basis, which possess a breakdown behavior analogous to those appropriate compounds based on fat-chemistry raw materials. For purposes of washing technology, the C₁₂-C₁₆ alkyl sulfates and C₁₂-C₁₅ alkyl sulfates, as well as C₁₄-C₁₅ alkyl sulfates, are preferred. 2,3-Alkyl sulfates that can be obtained, for example, as commercial products of the Shell Oil Company under the name DAN®, are also suitable anionic surfactants.

The concentration of anionic surfactants, by preference of the aforesaid anionic surfactants, in the agent according to the present invention can vary over a wide range depending on the purpose served by the relevant agent. For example, an agent according to the present invention can contain very large quantities of anionic surfactant, by preference up to on the order of 40, 50, or 60 wt % or more. An agent according to the present invention can likewise contain only very small quantities of anionic surfactant, for example less than 15 or 10 wt %, or less than 5 wt % or even less. Advantageously, however, anionic surfactants are contained in the agents according to the present invention in quantities from 0.1 to 40 wt %, and in particular 5 to 30 wt %, concentrations above 10 wt % and indeed above 15 wt % being especially preferred. According to a preferred embodiment, the agent according to the present invention contains anionic surfactants, by preference in quantities of at least 0.01 wt % based on the entire agent. According to another preferred embodiment, the agent according to the present invention can be free of anionic surfactant.

In addition to the aforesaid anionic surfactants, but also independently thereof, soaps can be contained in the agents according to the present invention. Saturated fatty-acid soaps, such as the salts of lauric acid, myristic acid, palmitic acid, stearic acid, hydrogenated erucic acid, and behenic acid, and soap mixtures derived in particular from natural fatty acids, e.g. coconut butter, palm oil, or tallow acids, are suitable. The soap content of the agent, independent of other anionic surfactants, is by preference no more than 3 wt % and in particular 0.5 to 2.5 wt %, based on the entire agent. According to another preferred embodiment, the agent according to the present invention is free of soap.

The anionic surfactants and soaps can be present in the form of their sodium, potassium, or ammonium salts, and as soluble salts of organic bases, such as mono-, di-, or triethanolamine. They are preferably present in the form of their sodium or potassium salts, in particular in the form of the sodium salts. Anionic surfactants and soaps can also be manufactured in situ by introducing, into the composition to be spray-dried, the anionic surfactant acids and, if applicable, fatty acids, which are then neutralized by the alkali carriers in the composition to be spray-dried.

Advantageously, nonionic surfactants can likewise be contained in the agents according to the present invention, both in solid and in liquid agents. For example, their concentration can be up to 2 or 3 or 5 wt %. Larger quantities of nonionic surfactant can also be contained, for example up to 5 wt % or 10 wt % or 15 wt % or 20 wt %, 30 wt %, 40 wt %, 50 wt %, or indeed more, if appropriate. Reasonable lower limits can lie at values of 0.01, 0.1, 1, 2, 3, or 4 wt %.

By preference, however, the nonionic surfactants are contained in larger quantities, i.e. up to 50 wt %, advantageously from 0.1 to 40 wt %, particularly preferably from 0.5 to 30 and in particular from 2 to 25 wt %, based in each case on the entire agent. According to a preferred embodiment, the agent according to the present invention contains nonionic surfactants, by preference in quantities of at least 0.1 wt % based on the entire agent. According to another preferred embodiment, the agent according to the present invention can be free of nonionic surfactant.

Advantageously, all nonionic surfactants known from the existing art can be contained in the agents according to the present invention. Preferred nonionic surfactants are presented below.

The cleaning, care-providing, and washing agents can by preference also contain cationic surfactants. Suitable cationic surfactants are, for example, surface-active quaternary compounds, in particular having an ammonium, sulfonium, phosphonium, iodonium, or arsonium group. The use of quaternary surface-active compounds having an antimicrobial effect allows the agent to be equipped with an antimicrobial effect, or allows its antimicrobial effect that may already be present on the basis of other ingredients to be improved.

Particularly preferred cationic surfactants are the quaternary ammonium compounds (QACs, INCI: Quaternary Ammonium Compounds), in part having antimicrobial action, according to the general formula (R^{I})(R^{II})(R^{III})(R^{IV})N⁺X⁻, in which R^{I} to R^{IV} represent identical or different C₁-C₂₂ alkyl radicals, C₇-C₂₈ aralkyl radicals, or heterocyclic radicals, two or (in the case of an aromatic bond such as in pyridine) even three radicals forming the heterocycle together with the nitrogen atom, for example a pyridinium or imidazolinium compound; and X⁻ are halide ions, sulfate ions, hydroxide ions, or similar anions. For an optimum antimicrobial action, at least one of the radicals preferably has a chain length from 8 to 18, in particular 12 to 16, carbon atoms.

A particularly preferred QAC is cocopentaethyoxymethylammonium methosulfate (INCI: PEG-5 Cocomonium Methosulfate; Rewoquat® CPEM).

To avoid possible incompatibilities between the antimicrobial cationic surfactants and the anionic surfactants contained in the agent according to the present invention, a surfactant that is as compatible as possible with anionic surfactant, and/or as little cationic surfactant as possible, is used; or, in a particular embodiment of the invention, cationic surfactants are entirely omitted.

Further cationic surfactants, including quaternary ammonium compounds, are described below especially in conjunction with conditioning agents and softeners. These, too, can be contained by preference in the agents according to the present invention.

The cleaning, care-providing, or washing agents according to the present invention can contain one or more cationic surfactants, advantageously in quantities (based on the entire composition) from 0 to 30 wt %, even more advantageously 0 to 20 wt %, by preference 0.01 to 10 wt %, in particular 0.1 to 5 wt %. Suitable minimum values can also be 0.5, 1, 2, or 3 wt %. According to a preferred embodiment, the agent according to the present invention contains cationic surfactants, by preference in quantities of at least 0.1 wt % based on the entire agent. According to another preferred embodiment, the agent according to the present invention can be free of cationic surfactant.

Similarly, the cleaning, care-providing, or washing agents according to the present invention can also contain amphoteric surfactants. These are described in even further detail below, especially in conjunction with conditioning agents and softeners.

The cleaning, care-providing, or washing agents according to the present invention can contain one or more amphoteric surfactants, advantageously in quantities (based on the total composition) from 0 to 30 wt %, even more advantageously greater than 0 to 20 wt %, by preference 0.01 to 10 wt %, in particular 0.1 to 5 wt %. According to another preferred embodiment, the agent according to the present invention can be free of amphoteric surfactants.

According to a specific embodiment, the agents according to the present invention can contain very little total surfactant; for example, the total surfactant quantity can be below 20 wt %, 15 wt %, 10 wt %, or 5 wt %, advantageously even below 3 wt % or below 1 wt %, in particular even below 0.5 wt % or below 0.1 wt %, the wt % being based in each case on the entire agent. By preference, however, the total surfactant content is at least 0.01 wt %, 0.1 wt %, or 1 wt %, based on the entire agent.

Further ingredients of the agents according to the present invention can be inorganic and organic builder substances. Included among the inorganic builder substances are water-insoluble or non-water-soluble ingredients such as aluminosilicates and, in particular, zeolites.

In a preferred embodiment, the agent according to the present invention contains no phosphate and/or no zeolite. It is also possible, however, for the agent to contain zeolite. It may then be preferred for said zeolite concentration, based on the total weight of the agent, to be less than 5 wt %, by preference at most 4 wt %, at most 3 wt %, or at most 2 wt %.

Provision can, however, also advantageously be made for the agent according to the present invention to have a zeolite content of at least 10 wt %, e.g. at least 15 wt % or at least 20 wt % or at least 30 wt % or even more, for example at least 50 wt %.

The agent according to the present invention can contain soluble builders by preference in quantities from 0.1 wt % to 30 wt %, preferably 5 wt % to 25 wt %, and particularly preferably 10 wt % to 20 wt %, based on the total weight of the agent, sodium carbonate being particularly preferred as a soluble builder. Provision can also advantageously be made, however, for the agent according to the present invention to contain less than 10 wt %, for example less than 5 wt %, soluble builders. Citrates, SKS-6, citric acid, MGDA (methylglycine diacetic acid), triphosphates, phosphonates, aliphatic dicarboxylic acids (e.g. adipic, glutaric, succinic acid), are suitable, for example. According to another preferred embodiment, the agent can also be free of soluble builder.

In cases in which a phosphate content is tolerated, the concurrent use of phosphates is also possible, in particular pentasodium triphosphate, optionally also pyrophosphates as well as orthophosphates, which function principally as precipitating agents for lime salts. Phosphates are used predominantly in automatic dishwashing agents, but to some extent also in laundry detergents.

Particularly preferred inorganic water-soluble builders are alkali-metal carbonates and alkali-metal bicarbonates; sodium and potassium carbonate, and in particular sodium carbonate, are included among the preferred embodiments. The concentration of alkali-metal carbonates in, especially, zeolite-free agents can vary over a very wide range, and is by preference 1 to 50 wt %, advantageously 5 to 40 wt %, in particular 8 to 30 wt %, the concentration of alkali-metal carbonates usually being higher than that of (X−)amorphous silicates. According to another preferred embodiment, the agent according to the present invention can be free of alkali-metal carbonates.

Usable organic builder substances are the polycarboxylic acids, usable e.g. in the form of their alkali and, in particular, sodium salts, such as citric acid, adipic acid, succinic acid, glutaric acid, tartaric acid, sugar acids, aminocarboxylic acids, nitrilotriacetic acid (NTA), provided such use is not objectionable for environmental reasons, as well as mixtures thereof. Preferred salts are the salts of polycarboxylic acids such as citric acid, adipic acid, succinic acid, glutaric acid, tartaric acid, sugar acids, and mixtures thereof. The acids themselves can also be used. The acids typically possess not only their builder effect but also the property of an acidifying component, and thus serve also to establish a lower and milder pH for washing, care-providing, and cleaning agents. Citric acid, succinic acid, glutaric acid, adipic acid, gluconic acid, and any mixtures thereof are to be recited in particular in this context.

Polymeric polycarboxylates are furthermore suitable as builders; these are, for example, the alkali-metal salts of polyacrylic acid or polymethacrylic acid, for example those having a relative molecular weight from 500 to 70,000 g/mol. For purposes of this document, the molecular weights indicated for polymeric polycarboxylates are weight-averaged molecular weights M_{w} of the respective acid form, which can have been determined in principle by gel permeation chromatography (GPC), a UV detector having been used. The measurement was performed against an external polyacrylic acid standard that, because of its structural kinship with the polymers being examined, provides realistic molecular weight values. These data deviate considerably from the molecular weight data when polystyrene sulfonic acids are used as a standard. The molar weights measured against polystyrene sulfonic acids are as a rule much higher than the molar weights indicated in this document.

The concentration of organic builder substances in the agents can vary over a wide range. Contents from 2 to 20 wt % are preferred, contents of at most 10 wt % being particularly well received. According to another preferred embodiment, the agent according to the present invention can be free of organic builder substances.

Be it noted at this juncture that the “wt %” indication refers in each case, unless otherwise indicated, to the entire agent.

The agents according to the present invention can also comprise components from the classes of the graying inhibitors (dirt carriers), the neutral salts, and the textile-softening adjuvants (e.g. cationic surfactants), which is preferred.

Suitable softeners, which are described more exhaustively below, are, for example swellable sheet silicates in the nature of corresponding montmorillonites, for example bentonite, as well as cationic surfactants.

The water content in the agent is based, among other factors, on whether the agent is present in liquid or solid form; it is therefore by preference from 0 to less than 100 wt %, and in particular 0.5 to 95 wt %, values of at most 5 wt % being especially preferred for solid or nonaqueous liquid agents. Not included in the calculation here in the case of the solid agents is the water adhering to aluminosilicates, such as zeolite, that may be present.

In the case of liquid agents, according to a preferred embodiment the agent according to the present invention contains water in a quantity of more than 20 wt %, advantageously more than 30 wt %, with further advantage more than 40 wt %, even more advantageously more than 50 wt %, in particular 60 to 99 wt %, particularly preferably 70 to 98 wt %, and extremely preferably 80 to 95 wt %, based on the entire agent.

The upper limit for water can also be 80 wt %, 70 wt %, 60 wt %, 50 wt %, 40 wt %, 30 wt %, 20 wt %, or 10 wt %, based on the entire agent.

The lower limit for water can also, for example, be 80 wt %, 70 wt %, 60 wt %, 50 wt %, 40 wt %, 30 wt %, 20 wt %, or 10 wt %, based on the entire agent.

The aforesaid upper and lower limits can of course be appropriately combined, for example in order to yield water contents of 60 to 80 wt % or 10 to 30 wt %, etc.

The agent according to the present invention, if it is a solid, can exhibit outstanding pouring behavior. According to a preferred embodiment, the agent according to the present invention substantially in solid form, being present by preference in powdered, pressed, or granular form.

The nonionic surfactants will be described below in further detail. These nonionic surfactants can be applied onto the particulate agents in a post-processing step. All nonionic surfactants can, however, advantageously be contained directly in the agent according to the present invention, which e.g. can be liquid or solid, or in the form of a foam or gel.

The nonionic surfactants that are used are by preference alkoxylated, advantageously ethoxylated, in particular primary alcohols having by preference 8 to 18 carbon atoms and an average of 1 to 12 mol ethylene oxide (EO) per mol of alcohol, in which the alcohol radical can be linear or preferably methyl-branched in the 2-position, or can contain mixed linear and methyl-branched radicals, such as those that are usually present in oxo alcohol radicals. Particularly preferred, however, are alcohol ethoxylates having linear radicals made up of alcohols of natural origin having 12 to 18 carbon atoms, e.g. from coconut, palm, palm kernel, tallow, or oleyl alcohol, and an average of 2 to 8 EO per mol of alcohol. The preferred ethoxylated alcohols include, for example, C₁₂ to C₁₄ alcohols having 3 EO to 6 EO, C₉₋₁₁ alcohols having 7 EO, C₁₃₋₁₅ alcohols having 3 EO, 5 EO, 7 EO, or 8 EO, C₁₄ to C₁₅ alcohols having 4 EO, 5 EO, 7 EO, or 9 EO, C₁₂₋₁₈ alcohols having 3 EO, 5 EO, or 7 EO, and mixtures thereof, such as mixtures of C₁₂ to C₁₄ alcohol having 3 EO and C₁₂ to C₁₈ alcohol having 7 EO. The degrees of ethoxylation indicated represent statistical averages that can be an integer or a fractional number for a specific product.

Preferred alcohol ethoxylates exhibit a restricted distribution of homologs (narrow range ethoxylates, NRE). In addition to these nonionic surfactants, fatty alcohols having more than 12 EO can also be used. Examples of these are (tallow) fatty alcohol having 14 EO, 16 EO, 20 EO, 25 EO, 30 EO, or 40 EO.

Preferred nonionic surfactants are one or more unbranched or branched, saturated or unsaturated C₁₀₋₂₂ alcohols alkoxylated with ethylene oxide (EO) and/or propylene oxide (PO), having a degree of alkoxylation up to 30, by preference ethoxylated C₁₀₋₁₈ fatty alcohols having a degree of ethoxylation of less than 30, preferably 1 to 20, in particular 1 to 12, particularly preferably 1 to 8, extremely preferably 2 to 5, for example C₁₂₋₁₄ fatty alcohol ethoxylates having 2, 3, or 40 EO, or a mixture of the C₁₂₋₁₄ fatty alcohol ethoxylates having 3 and 4 EO at a weight ratio of 1 to 1, or isotridecyl alcohol ethoxylate having 5, 8, or 12 EO.

Also usable as further nonionic surfactants are alkyl glycosides of the general formula RO(G)ₓ, in which R denotes a primary straight-chain or methyl-branched (in particular methyl-branched in the 2-position) aliphatic radical having 8 to 22, by preference 12 to 18 carbon atoms; and G is the symbol denoting a glycose unit having 5 or 6 carbon atoms, preferably glucose. The degree of oligomerization x, which indicates the distribution of monoglycosides and oligoglycosides, is any number from 1 to 10; by preference, x is between 1.2 and 1.4. N-methylglucamides with C₁₂/C₁₄ are also suitable.

A further class of nonionic surfactants used in preferred fashion, which are used either as the only nonionic surfactant or in combination with other nonionic surfactants, in particular together with alkoxylated fatty alcohols and/or alkyl glycosides, are alkoxylated, preferably ethoxylated or ethoxylated and propoxylated, fatty acid alkyl esters, by preference having 1 to 4 carbon atoms in the alkyl chain, in particular fatty acid methyl esters; particularly preferred are C₁₂ to C₁₈ fatty acid methyl esters having an average of 3 to 15 EO, in particular an average of 5 to 12 EO, are, for example, also usable.

Nonionic surfactants of the amine oxide type, for example N-cocalkyl-N,N-dimethylamine oxide and N-tallowalkyl-N,N-dihydroxyethylamine oxide, and the fatty acid alkanolamides, can also be suitable. The quantity of these nonionic surfactants is by preference no more than that of the ethoxylated fatty alcohols, in particular no more than half thereof.

Additionally suitable are alkoxylated amines, advantageously ethoxylated and/or propoxylated, in particular primary and secondary amines, having preferably 1 to 18 carbon atoms per alkyl chain and an average of 1 to 12 mol ethylene oxide (EO) and/or 1 to 10 mol propylene oxide (PO) per mol of amine.

In agents according to the present invention that are suitable in particular for automatic dishwashing, in particular dishwashing agents in the form of tabletted shaped elements, such as tabs, all surfactants are in principle suitable as surfactants. Preferred for this application, however, are specifically the nonionic surfactants described above, and in this context principally the low-foaming nonionic surfactants. The alkoxylated alcohols, in particular the ethoxylated and/or propoxylated alcohols, are particularly preferred. The skilled artisan understands “alkoxylated alcohols” to be generally the reaction products of alkylene oxide, in particular ethylene oxide, with alcohols, for purposes of the present invention preferably the longer-chain C₁₀ to C₁₈ alcohols, preferably from C₁₂ to C₁₆, such as C₁₁, C₁₂, C₁₃, C₁₄, C₁₅, C₁₆, C₁₇, and C₁₈ alcohols. As a rule, what results from n mol of ethylene oxide and one mol of alcohol, depending on the reaction conditions, is a complex mixture of addition products having different degree of ethoxylation. A further embodiment consists in the use of mixtures of alkylene oxides, preferably of the mixture of ethylene oxide and propylene oxide. It is also possible to arrive, if desired, by way of a concluding etherification with short-chain alkyl groups such as preferably the butyl group, at the substance class of the “capped” alcohol ethoxylates, which can likewise be used for purposes of the invention. Very particularly preferred for purposes of the invention are highly ethoxylated fatty alcohols, or mixtures thereof with end-capped fatty alcohol ethoxylates.

Advantageously, the agents according to the present invention can also contain foam inhibitors, for example foam-inhibiting paraffin oil or foam-inhibiting silicone oil, for example dimethylpolysiloxane. The use of mixtures of these active substances is also possible. Suitable additives that are solid at room temperature, especially in the context of the aforesaid foam-inhibiting active substances, are paraffin waxes, silicic acids that can also be hydrophobized in known fashion, and bisamides derived from C₂₋₇ diamines and from C₁₂₋₂₂ carboxylic acids.

The agents according to the present invention can by preference be mixed with further constituents, in particular of washing, care-providing, and/or cleaning agents or cosmetic ingredients. From the extensive existing art it is generally known which ingredients of washing, care-providing, or cleaning agents, and which raw materials, can usually also be mixed in. These are, for example, substances such as bleaching agents, bleach activators and/or bleach catalysts, enzymes, temperature-sensitive dyes, etc., which of course can also be contained directly in the agent.

If they are solid, the agents according to the present invention can also be present as tablets or shaped elements. “Tablet” or “shaped element” refers, in the context of the present Application, to dimensionally stable solid elements regardless of their manner of manufacture. Such elements can be manufactured, for example, by crystallization, casting, injection molding, reactive or thermal sintering, (co)extrusion, microencapsulation, pelletization, or compacting methods such as calendering or tableting. Manufacture of the “tablets” or “shaped elements” by tableting is particularly preferred in the context of the present invention. The tablet is therefore by preference made up of compressed particulate material.

Agents according to the present invention in solid form, present by preference as tablets or shaped elements, can by preference contain disintegration adjuvants. Appropriate swellable disintegration adjuvants are, for example, bentonites or other swellable silicates. Synthetic polymers, in particular the superabsorbers or crosslinked polyvinylpyrrolidone used in the hygiene sector, can also be used.

The agents according to the present invention can furthermore be present in the form of a conditioning agent and/or conditioner substrate, and can contain the components according to the invention. The term “conditioning” is by preference understood for purposes of this invention to mean the finishing treatment of textiles, materials, and fabrics. Conditioning imparts positive properties to the textiles, for example improved softness, elevated shine and color brilliance, an improved scent impression, decreased felting, easier ironing thanks to reduced friction properties, decreased wrinkling and static charging, and an inhibition of color transfer in the case of colored textiles.

Conditioning agents according to the present invention can advantageously have a pH of less than or equal to 8, by preference less than 7, particularly preferably between 1 and 6, and in particular between 2 and 5.

In a preferred embodiment, the conditioning agents according to the present invention can additionally contain surfactants. The additional use of surfactants effects an intensification of the conditioning properties, and moreover contributes to improve shelf stability, dispersibility, and emulsification capability of the individual conditioning-agent components.

In order to improve softness and finish properties, the agents according to the present invention can contain softener components. Examples of such compounds are quaternary ammonium compounds, cationic polymers, and emulsifiers, such as those used in hair-care agents and also in textile finishing agents. These softening compounds, which are also described below in more detail, can be contained in all agents according to the present invention but in particular in the conditioning agents or in agents that aim to have a softening effect.

Suitable examples are quaternary ammonium compounds of formulas (III) and (IV):

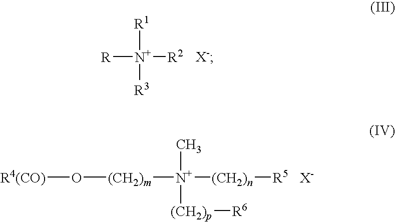

where in (III), R and R¹ denote an acyclic alkyl radical having 12 to 24 carbon atoms; R² denotes a saturated C₁ to C₄ alkyl or hydroxyalkyl radical; and R³ either is identical to R, R¹, or R² or denotes an aromatic radical. X⁻ denotes either a halide, methosulfate, methophosphate, or phosphate ion, and mixtures thereof. Examples of cationic compounds of formula (III) are didecyldimethylammonium chloride, ditallowedimethylammonium chloride, or dihexadecylammonium chloride.

Compounds of formula (IV) are so-called esterquats. Esterquats are notable for outstanding biodegradability. Here R⁴ denotes an aliphatic alkyl radical having 12 to 22 carbon atoms with 0, 1, 2, or 3 double bonds; R⁵ denotes H, OH, or O(CO)R⁷; and R⁶ denotes, independently of R⁵, H, OH, or O(CO)R⁸, R⁷ and R⁸ each denoting, mutually independently, an aliphatic alk(en)yl radical having 12 to 22 carbon atoms with 0, 1, 2, or 3 double bonds. m, n, and p can each, mutually independently, have a value of 1, 2, or 3. X⁻ can be either a halide, methosulfate, methophosphate, or phosphate ion, as well as mixtures thereof. Compounds that contain the group O(CO)R⁷ for R⁵, and alkyl radicals having 16 to 18 carbon atoms for R⁴ and R⁷, are preferred. Compounds in which R⁶ additionally denotes OH are particularly preferred. Examples of compounds of formula (IV) are methyl-N-(2-hydroxyethyl)-N,N-di(tallowacyloxyethyl)ammonium methosulfate, bis-(palmitoyl)ethylhydroxyethylmethylammonium methosulfate, or methyl-N,N-bis(acyloxyethyl)-N-(2-hydroxyethyl)ammonium methosulfate. If quaternized compounds of formula (IV) having unsaturated alkyl chains are used, those acyl groups whose corresponding fatty acids have an iodine number of between 5 and 80, preferably between 10 and 60, and in particular between 15 and 45, and that have a cis/trans isomer ratio (in wt %) greater than 30:70, by preference greater than 50:50, and in particular greater than 70:30, are preferred. Commercial examples are the methylhydroxyalkyldialkoyl oxyalkylammonium methosulfates marketed by Stepan under the trade name Stepantex®, or the products of Cognis known as Dehyquat®, or the products of Goldschmidt-Witco known as Rewoquat®. Further preferred compounds are the diesterquats of formula (V) that are obtainable under the name Rewoqua® W 222 LM or CR 3099, and provide not only softness but also stability and color protection:

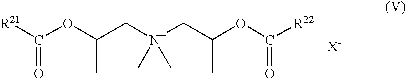

Here R²¹ and R²² each denote, mutually independently, an aliphatic radical having 12 to 22 carbon atoms with 0, 1, 2, or 3 double bonds.

In addition to the quaternary compounds described above, other known compounds, for example quaternary imidazolinium compounds of formula (VI), can also be used,

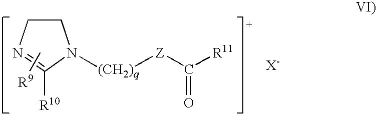

in which R⁹ denotes H or a saturated alkyl radical having 1 to 4 carbon atoms; R¹⁰ and R¹¹ each, mutually independently, denote an aliphatic, saturated, or unsaturated alkyl radical having 12 to 18 carbon atoms; R¹⁰ can alternatively also denote O(CO)R²⁰, where R²⁰ signifies an aliphatic, saturated, or unsaturated alkyl radical having 12 to 18 carbon atoms; Z signifies an NH group or oxygen; and X⁻ is an anion. q can assume integer values between 1 and 4.

Further suitable quaternary compounds are described by formula (VII),

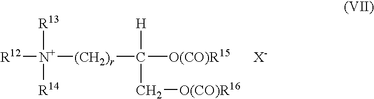

in which R¹², R¹³, and R¹⁴, mutually independently, denote a C₁₋₄ alkyl, alkenyl, or hydroxyalkyl group; R¹⁵ and R¹⁶, each selected independently, represent a C₈₋₂₈ alkyl group; and r is a number between 0 and 5.

In addition to the compounds of formulas (III) and (IV), short-chain water-soluble quaternary ammonium compounds can also be used, such as trihydroxyethylmethylammonium methosulfate or the alkyltrimethylammonium chlorides, dialkyldimethylammonium chlorides, and trialkylmethylammonium chlorides, e.g. cetyltrimethylammonium chloride, stearyltrimethylammonium chloride, distearyidimethylammonium chloride, lauryldimethylammonium chloride, lauryldimethylbenzylammonium chloride, and tricetylmethylammonium chloride.

Particularly preferred are alkylated quaternary ammonium compounds of which at least one alkyl chain is interrupted by an ester group and/or amido group, in particular N-methyl-N(2-hydroxyethyl)-N,N-(ditallowacyloxyethyl)ammonium methosulfate.

Suitable as nonionic softeners are, especially, polyoxyalkylene glycerol alkanoates, polybutylenes, long-chain fatty acids, ethoxylated fatty acid ethanolamides, alkylpolyglycosides, in particular sorbitan mono-, di-, and triesters, and fatty acid esters of polycarboxylic acids. Softeners can be contained in an agent according to the present invention, by preference a conditioning agent, in quantities from 0.1 to 80 wt %, usually 0.1 to 70 wt %, by preference 0.2 to 60 wt %, and in particular 0.5 to 40 wt %, based in each case on the entire agent.

Conditioning agents according to the present invention can by preference contain one or more anionic surfactants, in particular those that have already been described above.

Conditioning agents according to the present invention can by preference contain one or more nonionic surfactants, in particular those that have already been described above.

Further surfactants that are possible for all agents according to the present invention, in particular for the conditioning agents, are so-called Gemini surfactants. These are understood in general as compounds that possess two hydrophilic groups and two hydrophobic groups per molecule. These groups are usually separated from one another by a so-called “spacer.” This spacer is usually a carbon chain which should be sufficiently long that the hydrophilic groups have enough spacing that they can act mutually independently. Surfactants of this kind are generally characterized by an unusually low critical micelle concentration, and by the ability to greatly reduce the surface tension of water. In exceptional cases, however, the expression “Gemini surfactants” is understood to mean not only dimeric but also trimeric surfactants.

The agents according to the present invention by preference also contain amphoteric surfactants. In addition to numerous singly to triply alkylated amine oxides, the betaines also represent a significant class.

Betaines represent known surfactants that are manufactured predominantly by carboxyalkylation, by preference carboxymethylation, of amine compounds. The starting materials are preferably condensed with halogen carboxylic acids or salts thereof, in particular with sodium chloroacetate, one mol of salt being formed for each mol of betaine. Addition of unsaturated carboxylic acids, for example acrylic acid, is also possible. Regarding nomenclature and, in particular, the distinction between betaines and “true” amphoteric surfactants, reference may be made to the relevant technical literature. Examples of suitable betaines are represented by the carboxyalkylation products of secondary and, in particular, tertiary amines that conform to formula (IX)

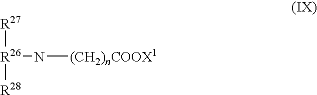

in which R²⁶ denotes alkyl and/or alkenyl radicals having 6 to 22 carbon atoms, R²⁷ denotes hydrogen or alkyl radicals having 1 to 4 carbon atoms, R²⁸ denotes alkyl radicals having 1 to 4 carbon atoms, n denotes numbers from 1 to 6, and X¹ denotes an alkali metal or alkaline earth metal or ammonium. Typical examples are the carboxymethylation products of hexyl methylamine, hexyl dimethylamine, octyl dimethylamine, decyl dimethylamine, dodecyl methylamine, dodecyl dimethylamine, dodecyl ethylmethylamine, C_{12/14} cocalkyl dimethylamine, myristyl dimethylamine, cetyl dimethylamine, stearyl dimethylamine, stearylethyl methylamine, oleyl dimethylamine, C_{16/18} tallowalkyl dimethylamine, and technical mixtures thereof.

In a preferred embodiment, the agents according to the present invention are present in liquid form, for example in the form of conditioning agents or liquid laundry detergents. The use both of liquid organic solvents and of water may be indicated in order to achieve a liquid consistency. The agents according to the present invention therefore, if applicable, contain solvents.

Solvents that can be used in the agents according to the present invention derive, for example, from the group of monovalent or polyvalent alcohols, alkanolamines, or glycol ethers, provided they are miscible with water in the concentration range indicated. The solvents are by preference selected from ethanol, n- or isopropanol, butanols, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl, or propyl ether, butoxypropoxypropanol (BPP), dipropylene glycol monomethyl or -ethyl ether, diisopropylene glycol monomethyl or -ethyl ether, methoxy-, ethoxy-, or butoxytriglycol, 1-butoxyethoxy-2-propanol, 3-methyl-3-methoxybutanol, propylene glycol t-butyl ether, and mixtures of these solvents. The agent according to the present invention, by preference a conditioning agent or liquid laundry detergent, can contain one or more solvents in a quantity of usually up to 90 wt %, by preference 0.1 to 30 wt %, in particular 2 to 20 wt %, particularly preferably 3 to 15 wt %, extremely preferably 5 to 12 wt %, for example 5.3 or 10.6 wt %, based in each case on the entire agent.

In a preferred embodiment, the cleaning, care-providing, or washing agent such as, in particular, the conditioning agent can optionally contain one or more complexing agents.

Complexing agents (INCI: Chelating Agents), also called “sequestering agents,” are ingredients that are capable of complexing and inactivating metal ions, for example in order to prevent their disadvantageous effects on the stability or appearance of the agents, e.g. clouding. On the one hand it is important in this context to complex the water-hardness calcium and magnesium ions that are incompatible with numerous ingredients. Complexing of the ions of heavy metals, such as iron or copper, delays oxidizing decomposition of the completed agents.

Preferred complexing agents are tertiary amines, in particular tertiary alkanolamines (aminoalcohols). The alkanolamines possess both amino groups and hydroxy and/or ether groups as functional groups. Particularly preferred tertiary alkanolamines are triethanolamine and tetra-2-hydroxypropylethylenediamine (N,N,N′,N′-tetrakis-(2-hydroxypropyl)ethylenediamine. Particularly preferred combinations of tertiary amines with zinc ricinoleate and one or more ethoxylated fatty alcohols as nonionic solubilizers, and optionally with solvents, are described in the existing art.

A particularly preferred complexing agent is etidronic acid (1-hydroxyethylidene-1,1-diphosphonic acid, 1-hydroxyethane-1,1-diphosphonic acid, HEDP, acetophosphonic acid, INCI: Etidronic Acid), including salts thereof. In a preferred embodiment, the agent according to the present invention accordingly contains, as a complexing agent, etidronic acid and/or one or more salts thereof.

In a particular embodiment, the agent according to the present invention contains a complexing-agent combination made up of one or more tertiary amines and one or more further complexing agents, by preference one or more complexing-agent acids or salts thereof, in particular made up of triethanolamine and/or tetra-2-hydroxypropylethylenediamine and etidronic acid and/or one or more salts thereof.

The cleaning, care-providing, or washing agent according to the present invention, such as in particular a conditioning agent, advantageously contains complexing agents in a quantity usually from 0 to 20 wt %, by preference 0.1 to 15 wt %, in particular 0.5 to 10 wt %, particularly preferably 1 to 8 wt %, extremely preferably 1.5 to 6 wt %, based on the entire agent.

In a further embodiment, the cleaning, care-providing, or washing agent, such as in particular a conditioning agent, optionally contains one or more viscosity regulators that by preference function as thickeners.

The viscosity of agents according to the present invention that are liquid can be measured with usual standard methods (e.g. Brookfield RVD-VII viscosimeter at 20 rpm and 20° C., spindle 3), and is by preference in the range from 10 to 5000 mPas. Preferred liquid to gelled agents have viscosities from 20 to 4000 mPas, values between 40 and 2000 mPas being particularly preferred.

Suitable thickeners are inorganic or polymeric organic compounds. Mixtures of several thickeners can also be used.

Included among the inorganic thickeners are, for example, polysilicic acids, clay minerals such as montmorillonites, zeolites, silicic acids, aluminum silicates, sheet silicates, and bentonites.

The organic thickeners derive from the groups of the natural polymers, the variant natural polymers, and the entirely synthetic polymers.

Polymers deriving from nature that are utilized as thickeners are, for example, xanthan, agar-agar, carrageenan, tragacanth, gum arabic, alginates, pectins, polyoses, guar flour, gellan gum, locust bean flour, starch, dextrins, gelatins, and casein.

Variant natural substances derive principally from the group of the modified starches and celluloses; examples that may be cited here are carboxymethyl cellulose and other cellulose ethers, hydroxyethyl and -propyl cellulose, highly etherified methylhydroxyethyl cellulose, and seed flour ethers.

In a further preferred embodiment, the cleaning, care-providing, or washing agent, such as in particular a conditioning agent, optionally contains one or more enzymes.

Suitable enzymes are, in particular, those from the classes of hydrolases, such as proteases, esterases, lipases or lipolytically active enzymes, amylases, cellulases and other glycosyl hydrolases, and mixtures of the aforesaid enzymes. All these hydrolases contribute, in the laundry, to the removal of stains such as protein-, grease-, or starch-containing stains, and graying. Cellulases and other glycosyl hydrolases can moreover contribute to color retention and to enhanced textile softness by removing pilling and microfibrils. Oxidoreductases can also be used for bleaching and to inhibit color transfer.

The enzymes can be adsorbed as shaped elements onto carrier substances, or embedded in coated fashion, in order to protect them from premature decomposition. The proportion of enzymes, enzyme mixtures, or enzyme granulates can be, for example, 0.1 to 5 wt %, by preference 0.12 to approximately 2 wt %, based on the entire agent. The washing or cleaning agents or care-providing agents (e.g. conditioning agents) according to the present invention can, if applicable, contain bleaching agents. Among the compounds yielding H₂O₂ in water and serving as bleaching agents, sodium percarbonate, sodium perborate tetrahydrate and sodium perborate monohydrate have particular importance. Additional usable bleaching agents are, for example, peroxypyrophosphates, citrate perhydrates, and peracid salts or peracids that yield H₂O₂, such as persulfates or persulfuric acid. Also usable is the urea peroxohydrate percarbamide, which can be described by the formula H₂N—CO—NH₂H₂O₂. Especially in the context of the use of agents for the cleaning of hard surfaces, for example for automatic dishwashing, they can also, if desired, contain bleaching agents from the group of the organic bleaching agents, although their use is also possible in principle in agents for textile laundering. Typical organic bleaching agents are the diacyl peroxides such as, for example, dibenzoyl peroxide. Further typical organic bleaching agents are the peroxy acids, the alkylperoxy acids and arylperoxy acids being mentioned in particular as examples. Preferred representatives are peroxybenzoic acid and its ring-substituted derivatives, such as alkylperoxy-benzoic acids, but peroxy-α-naphthoic acid and magnesium monoperphthalate; the aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid, and N-nonenylamidopersuccinates; and aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic) acid, can also be used.

The bleaching agents can by preference be coated in order to protect them from premature decomposition.

Dyes can be used in the agent according to the present invention, the quantity of one or more dyes being selected to be sufficiently low that no visible residues remain after application of the agent. The agent according to the present invention is by preference free of dyes.

The agent according to the present invention can by preference contain one or more antimicrobial active substances or preservatives, in a quantity usually from 0.0001 to 3 wt %, by preference 0.0001 to 2 wt %, in particular 0.0002 to 1 wt %, particularly preferably 0.0002 to 0.2 wt %, extremely preferably 0.0003 to 0.1 wt %.

A differentiation of antimicrobial active substances or preservatives is made, depending on the antimicrobial spectrum and mechanism of action, as between bacteriostatics and bactericides, fungistatics and fungicides, etc. Important substances from these groups are, for example, benzalkonium chlorides, alkylarylsulfonates, halogen phenols, and phenol mercuric acetate. The terms “antimicrobial action” and “antimicrobial active substance” have, in the context of the teaching of the present invention, the meaning usual in the art. Suitable antimicrobial active substances are by preference selected from the groups of the alcohols, amines, aldehydes, antimicrobial acids and salts thereof, carboxylic acid esters, acid amides, phenols, phenol derivatives, diphenyls, diphenylalkanes, urea derivatives, oxygen and nitrogen acetals and formals, benzamidines, isothiazolines, phthalimide derivatives, pyridine derivatives, guanidines, antimicrobial surface-active compounds, guanidines, antimicrobial amphoteric compounds, quinolines, 1,2-dibromo-2,4-dicyanobutane, iodo-2-propylbutylcarbamate, iodine, iodophores, peroxo compounds, halogen compounds, and any mixtures of the above.

The quaternary ammonium compounds (QACs), which are suitable as antimicrobial active substances, have already been described above. Particularly suitable, for example, is benzalkonium chloride, etc. Benzalkonium halides and/or substituted benzalkonium halides are obtainable commercially, for example, as Barquat® from Lonza, Marquat® from Mason, Variquat® from Witco/Sherex, and Hyamine® from Lonza, as well as Bardac® from Lonza. Further commercially obtainable antimicrobial active substances are N-(3-chlorallyl)hexaminium chloride such as Dowicide® and Dowicil® from Dow, benzethonium chloride such as Hyamine® 1622 from Rohm & Haas, methylbenzethonium chloride such as Hyamine® 10× from Rohm & Haas, and cetylpyridinium chloride such as Cepacol chloride from Merrell Labs.

The agents according to the present invention, in particular conditioning agents, can be obtained in accordance with all known techniques familiar to the skilled artisan. The agents can be obtained, for example, by mixture directly from their raw materials, optionally with the use of high-shear mixing equipment. For liquid formulations, in particular conditioning agents, what is advisable is, for example, melting of softener compounds that may be present, and subsequent dispersion of the melt in a solvent, by preference water.

The conditioners are by preference present as softening rinse agents. They are usually introduced into the rinse cycle of an automatic washing machine.

A further subject of the invention is a substrate, in particular a conditioner substrate, that is impregnated and/or coated with an agent according to the present invention, in particular a conditioning agent, that therefore contains, in addition to other constituents, the fragrance composition according to the present invention.

Conditioner substrates according to the present invention are used principally in textile treatment, and in particular in textile drying processes. The substrate material is by preference made up of porous flat sheets. They can be made of a flexible fibrous or cellular material that has sufficient thermal stability for use in the dryer and that can retain sufficient quantities of an impregnation or coating agent to effectively condition materials without resulting, during storage, in appreciable discharge or bleeding of the agent. Included among these sheets are sheets made of woven and nonwoven synthetic and natural fibers, felt, paper, or foamed material, such as hydrophilic polyurethane foam.

A further subject of the invention is the use of a conditioning agent according to the present invention, or of a conditioner substrate according to the present invention, in a textile conditioning method such as, for example, a rinse cycle, a textile drying process, and a textile dry-cleaning or textile freshening method. A conditioning substrate, made e.g. of wood, paper, leather, or the like, is also usable as a room scenting agent.

A complete laundry detergent according to the present invention in powder form can by preference contain, in addition to the light-active bleaching agent, for example components that are selected from the following:
anionic surfactants such as, for example, alkylbenzenesulfonate, alkyl sulfate, in quantities advantageously from 5 to 30 wt %, by preference 8 to 15 wt %, in particular 15 to 20 wt %,
nonionic surfactants such as, for example, fatty alcohol polyglycol ether, alkylpolyglucoside, fatty acid glucamide, advantageously 0.1 to 20 wt %, by preference 2 to 15 wt %, in particular 6 to 11 wt %,
detergency builders such as, for example, zeolite, polycarboxylate, sodium citrate, 5 to 60 wt %, by preference 10 to 55 wt %, in particular 15 to 40 wt %,
alkalis such as, for example, sodium carbonate, advantageously 1 to 30 wt %, by preference 2 to 25 wt %, in particular 5 to 20 wt %,
additional bleaching agents such as, for example, sodium perborate, sodium percarbonate, advantageously 5 to 25 wt %, by preference 10 to 20 wt %, corrosion inhibitors, e.g. sodium silicate, advantageously 1 to 6 wt %, by preference 2 to 5 wt %, in particular 3 to 4 wt %,
stabilizers, e.g. phosphonates, advantageously 0 to 1 wt %, foam inhibitor, e.g. soap, silicone oils, paraffins, advantageously 0.1 to 4 wt %, by preference 0.2 to 2 wt %, in particular 1 to 3 wt %,
enzymes, e.g. proteases, amylases, cellulases, lipases, advantageously 0.1 to 2 wt %, by preference 0.2 to 1 wt %, in particular 0.3 to 0.8 wt %,
graying inhibitor, e.g. carboxymethyl cellulose, advantageously 0 to 1 wt %,
discoloration inhibitor, e.g. polyvinylpyrrolidone derivatives, advantageously 0 to 2 wt %,
adjusting agent, e.g. sodium sulfate, advantageously 0 to 20 wt %,
optical brightener, e.g. stilbene derivative, biphenyl derivative, advantageously 0.1 to 0.4 wt %, in particular 0.1 to 0.3 wt %,
fragrances,
water,
soap,
bleach activators,
cellulose derivatives,
dirt repellents.

A liquid complete laundry detergent according to the present invention can by preference contain, in addition to the light-active bleaching agent, for example components that are selected from the following:
anionic surfactants such as, for example, alkylbenzenesulfonates, alkyl sulfate, in quantities advantageously from 5 to 40 wt %, by preference 8 to 30 wt %, in particular 15 to 25 wt %,
nonionic surfactants such as, for example, fatty alcohol polyglycol ethers, alkylpolyglucoside, fatty acid glucamide, advantageously 0.1 to 25 wt %, by preference 5 to 20 wt %, in particular 10 to 15 wt %,
detergency builders such as, for example, zeolite, polycarboxylate, sodium citrate, advantageously 0 to 15 wt %, by preference 0.01 to 10 wt %, in particular 0.1 to 5 wt %,
foam inhibitor, e.g. soap, silicone oils, paraffins, advantageously 0.1 to 4 wt %, by preference 0.2 to 3 wt %, in particular 1 to 2 wt %,
enzymes, e.g. proteases, amylases, cellulases, lipases, advantageously 0.1 to 2 wt %, by preference 0.2 to 1 wt %, in particular 0.3 to 0.8 wt %,
optical brightener, e.g. stilbene derivative, biphenyl derivative, advantageously 0.1 to 0.4 wt %, in particular 0.1 to 0.3 wt %,
fragrances,
stabilizers,
water,
soap, advantageously 1 to 20 wt %, by preference 2 to 15 wt %, in particular 5 to 10 wt %,
alcohols/solvents, advantageously 0 to 25 wt %, by preference 1 to 20 wt %, in particular 2 to 15 wt %.

The agents according to the present invention can by preference also be perfumed with perfume oil (odorants, fragrances).

The term “perfume oil” by preference means self-contained fragrance compositions that are generally used for product scenting and, in particular, are pleasant-smelling in human estimation. This may be explained using an example. If a skilled artisan wishes, for example, to make a shower gel pleasant-smelling, he or she usually adds not just one (pleasantly) odoriferous substance but a collective of (pleasantly) odoriferous substances. Such a collective is usually made up of a plurality of individual odorants, for example more than 10 or 15, by preference up to 100 or more. These odorants constitute, in coaction, a desired pleasant-smelling and harmonious olfactory image.

A perfume oil according to the present invention can contain individual odorant compounds, e.g. the synthetic products of the ester, ether, aldehyde, ketone, alcohol, and hydrocarbon types. Odorant compounds of the ester type are, for example, benzyl acetate, phenoxyethyl isobutyrate, p-tert.-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate, and jasmecyclate. The ethers include, for example, benzyl ethyl ether and ambroxan; the aldehydes, for example, the linear alkanals having 8 to 18 carbon atoms, citral, citronellal, citronellyloxyacetaldehyde, cyclamenaldehyde, lilial, and bourgeonal; the ketones, for example, the ionones, α-isomethylionone und methylcedryl ketone; the alcohols, anethol, citronellol, eugenol, geraniol, linalool, phenylethyl alcohol and terpineol; and the hydrocarbons include principally the terpenes such as limonene and pinene. Preferably, however, mixtures of different odorants that together produce an attractive fragrance note in the resulting perfume oil are used.

The perfume oils can also, however, contain natural odorant mixtures such as those accessible from plant sources, for example pine, citrus, jasmine, patchouli, rose, or ylang-ylang oil. Also suitable are muscatel sage oil, chamomile oil, clove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil.

In a preferred embodiment, the agent according to the present invention contains specific minimum values in terms of perfume oil, namely at least 0.00001 wt %, advantageously at least 0.0001 wt %, in considerably advantageous fashion at least 0.001 wt %, in more advantageous fashion at least 0.01 wt %, with further advantage at least 0.1 wt %, in even more advantageous fashion at least 0.2 wt %, in very advantageous fashion at least 0.3 wt %, in particularly advantageous fashion at least 0.4 wt %, in very particularly advantageous fashion at least 0.45 wt %, in considerably advantageous fashion at least 0.5 wt %, in very considerably advantageous fashion 0.55 wt %, in extremely advantageous fashion at least 0.6 wt %, in most highly advantageous fashion at least 0.65 wt %, exceedingly advantageously at least 0.7 wt %, in exceptionally advantageous fashion at least 0.75 wt %, in unusually advantageous fashion at least 0.8 wt %, in extraordinarily advantageous fashion at least 0.85 wt %, in particular at least 0.9 wt % perfume oil, based on the entire agent.

According to a further preferred embodiment, the agent according to the present invention can be free of perfume oil.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

What is claimed:

1. A composition comprising a washing, care-providing, or cleaning agent and a light-active bleaching agent titanium dioxide.

2. The composition of claim 1, wherein the titanium dioxide comprises a modified titanium dioxide.

3. The composition of claim 2, wherein modified titanium dioxide comprises a carbon-modified titanium dioxide.

4. The composition of claim 1, comprising 0.000001% to 25% by weight of the modified titanium dioxide.

5. The composition of claim 4, comprising 0.01% to 5% by weight of the modified titanium dioxide.

6. The composition of claim 3, wherein the carbon-modified titanium dioxide comprises 0.01% to 10% by weight of carbon.

7. The composition of claim 6, wherein the carbon-modified titanium dioxide comprises 0.05% to 5.0% by weight of carbon.

8. The composition of claim 7, wherein the carbon-modified titanium dioxide comprises 0.3% to 1.5% by weight of carbon.

9. The composition of claim 8, wherein the carbon-modified titanium dioxide comprises 0.4% to 0.8% by weight of carbon.

10. The composition of claim 2, wherein the modified titanium dioxide has a specific surface area according to BET of 50 m²/g to 500 m²/g.

11. The composition of claim 10, wherein the modified titanium dioxide has a specific surface area according to BET of 100 m² μg to 400 m²/g.

12. The composition of claim 11, wherein the modified titanium dioxide has a specific surface area according to BET of 200 m²/g to 350 m²/g.

13. The composition of claim 2, wherein the modified titanium dioxide has a particle size of 2 nm to 600 nm.

14. The composition of claim 13, wherein the modified titanium dioxide has a particle size of 200 nm to 400 nm.

15. The composition of claim 1, contained in an opaque package.

16. A method for textile treatment, comprising contacting a textile with the composition of claim 1 during or followed by exposuring the textile to light having a wavelength of 300 nm to 1200 nm.

17. A method for treating hard surfaces, comprising contacting the hard surface with the composition of claim 1 during or followed by exposuring the contacted surface to light having a wavelength in the range from 300 nm to 1200 nm.
